(19) United States
(12) Patent Application Publication
(10) Pub. No.: US 2025/0083934 A1
(43) Pub. Date: Mar. 13, 2025

(54) A DEVICE FOR PICKING UP AND DEPOSITING LOADS

(71) Applicant: ROGAMA B.V., VALKENBURG (NL)

(72) Inventor: Robert Servaas MATTI, VALKENBURG (NL)

(21) Appl. No.: 18/727,522

(22) PCT Filed: Dec. 16, 2022
(86) PCT No.: PCT/NL2022/050724

§ 371 Date: Jul. 9, 2024

(30) Foreign Application Priority Data
Jan. 12, 2022 (NL) 2030508

(51) Int. Cl. B66F 9/14

(52) U.S. Cl. CPC B66F 9/14

(57) ABSTRACT

A device for picking up and depositing loads including at least one supporting body, at least one carrying body and at least one pickup body configured for picking up and depositing at least one load, wherein the pickup body is movable between a first position in which the pickup body at least mainly extends in or along the carrying body and a second position in which the pickup body at least mainly extends outside or away from the carrying body.

The invention relates to a device for picking up and depositing loads, such as boxes.

The invention further relates to a lift truck comprising such a device for picking up and depositing loads.

WO 96/13457 discloses a device for picking up, transporting and depositing loads, such as loaded pallets, comprising a carrying body with at least one load supporting element of the type, that is adapted to be inserted from aside under a load. The device is mounted with its carrying body for up and down movement on a vertical guide track at the front side of a fork lift truck. In the carrying body guiding tracks are provided. The load supporting element is mounted to move along said tracks between a retracted position and an extended position to be inserted from aside under a load, such as a loaded pallet. In this manner the manoeuvring of a truck in a working space with the device with the load supporting element in the retracted position is much easier and due to the absence of an extending load supporting element much less dangerous than with the traditional fork lift trucks.

A drawback of the known device is that after picking up a load, the device with the load are a single unit which can only be moved by means of a lift truck.

It is an object of the present invention to provide an improved device, such as for example an improved device configured to move a load carried by the device.

The above object is achieved with a device as defined in claim 1.

The device for picking up and depositing loads comprising at least one supporting body, at least one carrying body and at least one pickup body configured for picking up and depositing at least one load, wherein the pickup body is movable between a first position in which the pickup body at least mainly extends in or along the carrying body and a second position in which the pickup body at least mainly extends outside or away from the carrying body, wherein the carrying body is connected to the supporting body by means of a rotator for rotating the carrying body and the pickup body around a rotation axis.

In this manner, an improved device is provided, because a load after being picked up by the pickup body of the device can be moved, i.e. rotated, by means of the rotator of the device. The improved device makes it possible to orient a load, such as a box or a package, in a preferred orientation or between preferred orientations by rotating the object by means of the rotator during an operation. This may facilitate the manoeuvrability of the device with the object in particular during transport. In addition, rotation of the load can optimize weight distribution. Further, it is possible to rotate the load between pickup and deposition to obtain efficiently deposited loads, for example stacks of predetermined dimensions. Such a stack may also comprise deposited packages (loads) with different dimensions in relation to each other. In addition, it is possible to rotate the pickup body by means of the rotator in its first position and/or in its second position, which provides improved freedom to pick up and deposit loads at least in an area around the rotation axis of the rotator. The pickup body is configured for picking up and depositing loads, i.e. a load is detachable attachable to the pickup body, for example in a hanging manner. The pickup body carrying a load can also move the load in a non-rotating manner, i.e. by moving the pickup body with the load between the first position and the second position.

In one aspect, the at least one carrying body is an elongate carrying body with a longitudinal axis. The pickup body is movable between a first position in which the pickup body at least mainly extends in or along the elongate carrying body in the same direction as the longitudinal axis of the elongate carrying body and a second position in which the pickup body at least mainly extends outside or away from the carrying body in a direction traverse to the longitudinal axis of the elongate carrying body. The longitudinal axis of the elongate carrying body extends in the same direction as the rotation axis of the rotator of the device. In a further aspect, the at least one supporting body is an elongate supporting body with a longitudinal axis extending in a direction traverse to the direction of the longitudinal axis of the elongate carrying body. The at least one supporting body can together with other components of the device be moved in a vertical direction by means of a vertical guide track of a lift truck, but with respect to other components of the device, the at least one supporting body is stationary. In other words, in the device of this disclosure the at least one supporting body is stationary.

In certain aspects, the device further comprises a guiding body for moving the carrying body and the pickup body in a direction traverse to the rotation axis of the rotator. The guiding body may be an elongate guiding body with a longitudinal axis. The elongate guiding body has for example at least one rail-like construction for moving the carrying body and the pickup body with or without a load in the direction of the longitudinal axis of the elongate guiding body. The range measured from the rotation axis of the device for picking up and depositing loads or objects is further increased by the guiding body, in that by moving the pickup body from the first position into the second position a first pickup range measured from the rotation axis is obtained, wherein the first pickup range is further extended into a second pickup range measured from the rotation axis by means of the guiding body which moves the carrying body and the pickup body in a direction traverse to the rotation axis of the rotator. In addition, between pickup and deposition a load may also be moved in a non-rotating manner by the guiding body of the device.

In another aspect, the pickup body is a rigid chain actuator, wherein a chain end of the rigid chain actuator is provided with pick-up units for picking up loads such as boxes, preferably the pick-up units are suction cups. The rigid chain actuator provides a compact device in the first position and a device with a relatively large range measured from the rotation axis of the device for picking up and depositing loads in the second position, in particular if a chain end of the rigid chain actuator is provided with pick-up units. Further, the rigid chain actuator requires relatively minimal maintenance and has a relatively long life span.

In a further aspect, the device further comprises a guiding unit for moving the carrying body and the pickup body in a direction traverse to the rotation axis of the rotator. Such an improved device may further increase the range measured from the rotation axis of the device for picking up and depositing loads or objects. In other words, the second pickup range is further extended into a third pickup range by means of the guiding unit which moves the guiding body, the carrying body and the pickup body in a direction traverse to the rotation axis of the rotator. The guiding unit is adapted for moving the carrying body and the pickup body in a direction transverse to the direction of displacement of the guiding body, i.e. crosswise. In this way, the guide unit can advantageously assist in depositing a load in a predetermined orientation, for example in depositing one elongate load parallel to and next to another elongate load on a carrier such as on a pallet.

In another aspect, in the first position the pickup body mainly extends in the same direction as the rotation axis of the rotator, wherein in the second position the pickup body mainly extends in a direction traverse to the rotation axis, i.e. crosswise to the rotation axis. The words “mainly extend” serve to indicate that more than 50% of the largest dimension of the pickup body extends in in the same direction as the rotation axis of the rotator or in a direction traverse, preferably more than 75%.

It is also an object to provide an improved lift truck. This object is achieved with the claim directed to a lift truck using the device as disclosed in this document. Finally the invention also relates to the use of the device disclosed in this document or the use of a lift truck as disclosed. By means of the device of this disclosure, it is possible to provide a lift truck with a relatively small width, such that the lift truck can be driven through aisles with a relatively small width, whereas loads can be picked up and/or deposited by means of the device from shelves located on opposite sides of the lift truck. Aisles with relatively small widths facilitate in creating a high-density storage system that makes it possible to increase the capacity of a warehouse without expanding the space. The device can advantageously be used for picking up or depositing loads in an aisle whose width is smaller than the length of the lift truck, such that the lift truck cannot turn around in the aisle.

The aspects described above as well as other aspects of the device or the lift truck will be explained hereunder on the basis of exemplary embodiments in combination with the figures. The invention is not, however, limited to the exemplary embodiments described hereunder. Rather, a number of adaptations and modifications are possible, which also make use of the idea of the invention claimed in the claims and consequently fall within the scope of protection. In particular, the possibility is mentioned of combining the features/aspects that are only mentioned in the description and/or are shown in the figures, with the features of the claims in so far as compatible.

### BRIEF DESCRIPTION OF THE DRAWINGS

FIG. 1a,b show perspective views of a device for picking up and depositing loads;

FIGS. 2a-c show perspective views of a lift truck with the device shown in FIG. 1a,b in various operating modes;

FIG. 3a,b show perspective views of the lift truck shown in FIGS. 2a-c picking up and depositing elongate loads;

FIGS. 4a-c show perspective views of a lift truck and a modified device for picking up and depositing loads with respect to the device shown in the other figures.

In the figures, the same components are indicated with the same reference signs.

### DETAILED DESCRIPTION OF THE DRAWINGS

This disclosure relates to a device for picking up and depositing loads and to a lift truck.

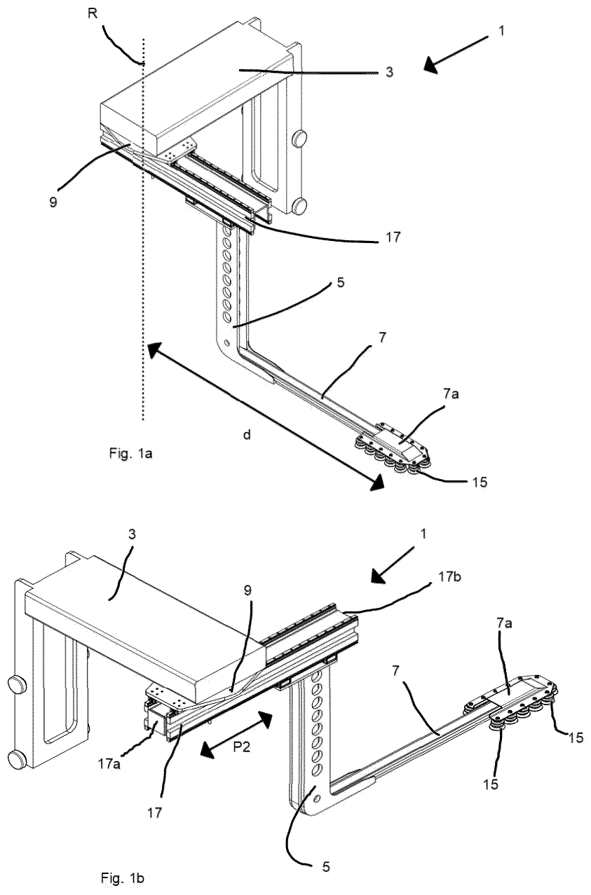

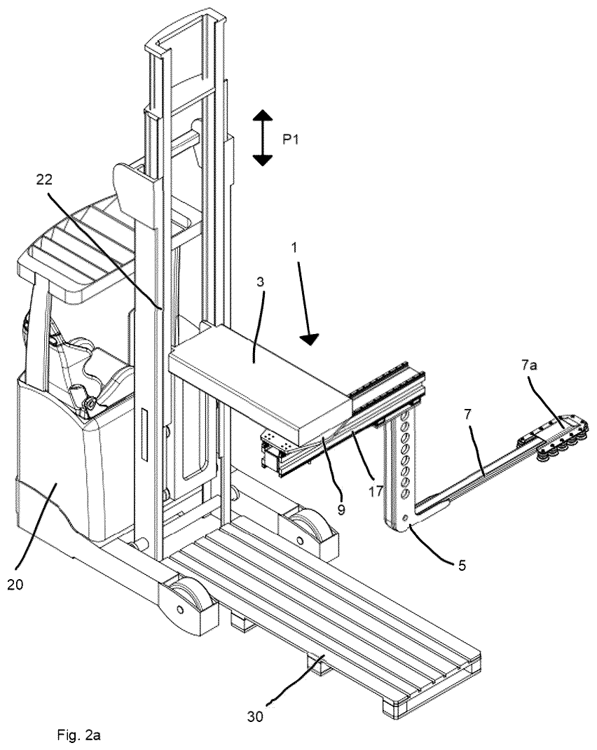

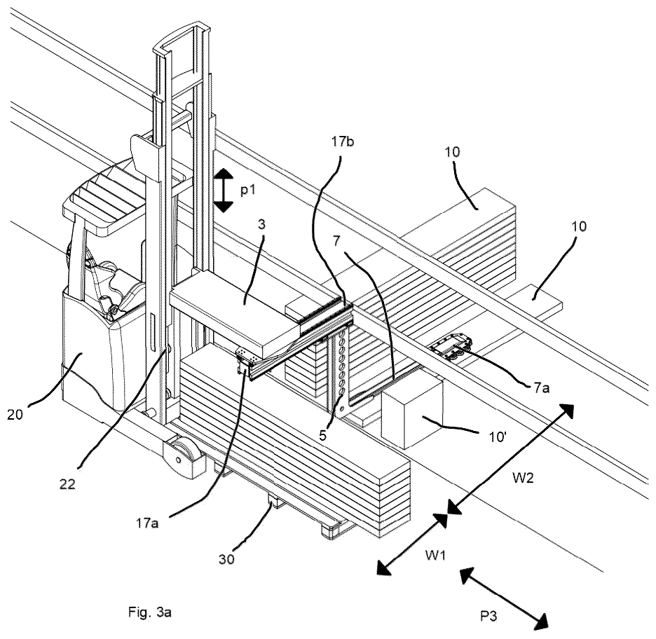

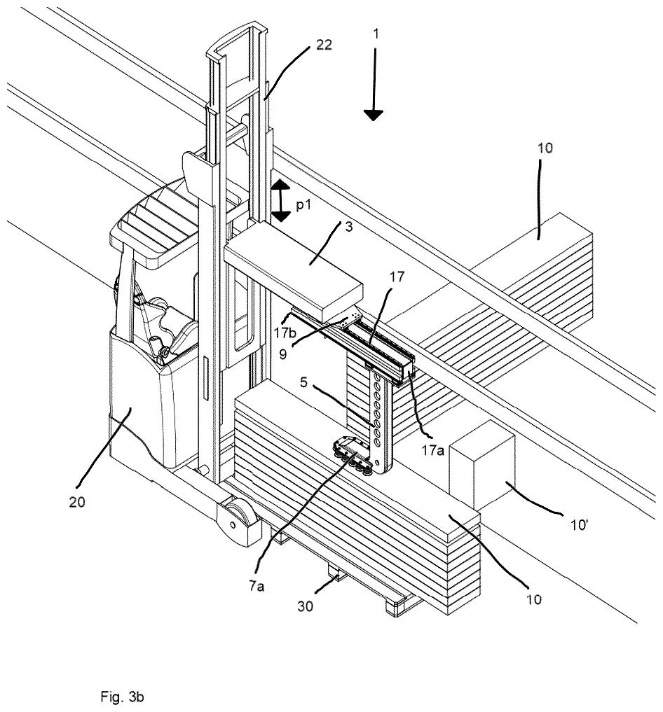

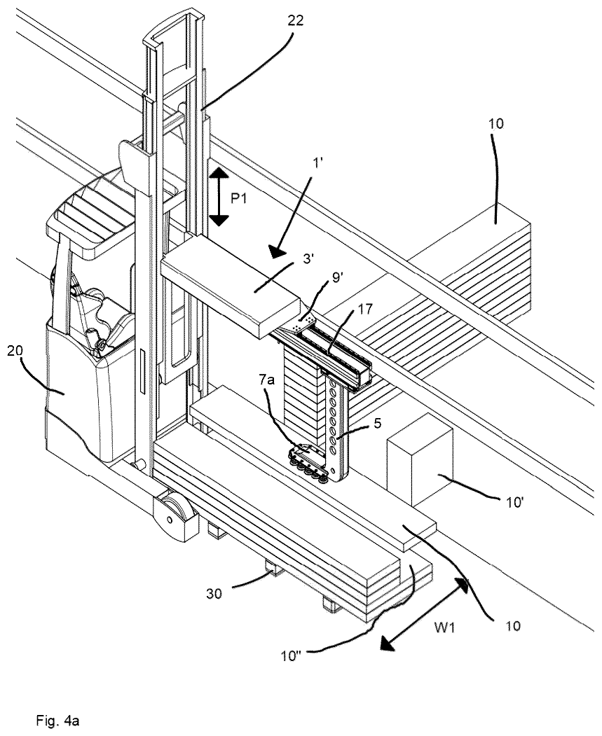

FIG. 1a,b show the device 1 for picking up and depositing loads 10, 10′ (see FIG. 3a) comprising at least one supporting body 3, at least one carrying body 5 and at least one pickup body 7 configured for picking up and depositing at least one load. The device 1 further comprises a rotator 9, wherein the carrying body 5 is connected to the supporting body 3 by means of the rotator 9 for rotating the carrying body 5 and the pickup body 7 around a rotation axis R indicated with a dashed line in FIG. 1b.

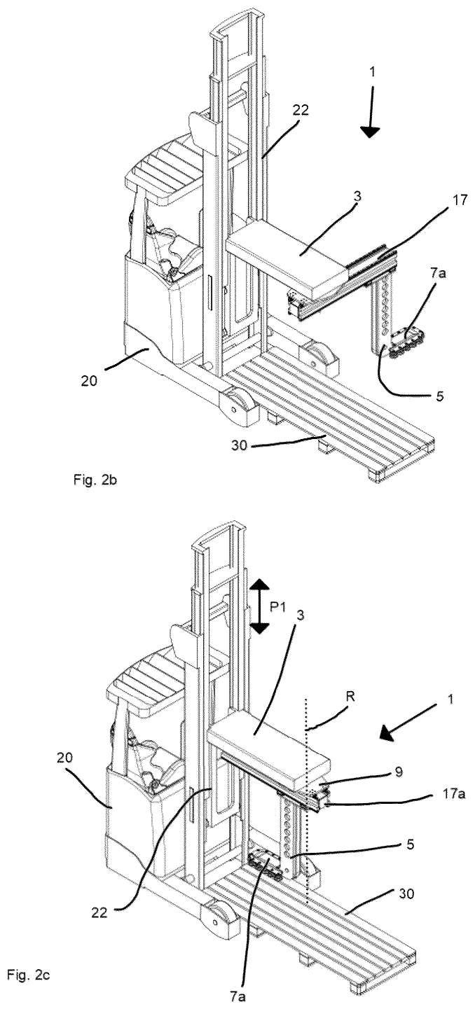

FIGS. 2a-3b show the lift truck 20 and the device 1 shown in FIG. 1a,b mounted on the lift truck 20. The supporting body 3 is adapted to be mounted in a detachable manner on the lift truck 20, for example the supporting body 3 may be mounted on the forks (not shown) of the lift truck 20. However, it may also be possible that the lift truck is provided with a fixed supporting body, in particular for lift trucks only used for the operations to be performed with the device as disclosed in this document. In this context “fixed” means that for example removing requires more effort from an operator than attaching or detaching the supporting body 3 within a few minutes. As shown in the FIG. 2a,b, the device 1 is provided on a vertical guide 30 track 22 at the front side of the lift truck 20. In this manner, the device 1 including the supporting body 3 is moveable in the same direction as the rotation axis R of the rotator 9, i.e. the device 1 is movable by means of the lift truck 20 in a vertical manner in the directions indicated by arrow P1. At the front side, the lift truck 20 further comprises a carrier for a pallet 30 or the like.

In FIG. 1a, b the pickup body 7 is shown in a position, hereafter the second position, wherein the distance d between the rotation axis R and an end 7a of the pickup body 7 is maximal. As shown in FIGS. 2a-3b, this distance (d in FIG. 1a) between the rotation axis R and the end 7a of the pickup body 7 can be varied. In FIG. 2c, the distance between the rotation axis R of the rotator 9 and an end 7a of the pickup body 7 is minimal or at least close to minimal. The pickup body 7 is adapted to be movable from a first position (as shown in FIGS. 2b,c and 3b) in which the pickup body 7 at least mainly extends in or along the carrying body 5 (in the height direction of the device) to the second position (as shown in FIGS. 1a,b, 2a and 3a) in which the pickup body 7 at least mainly extends outside or away from the carrying body 5 (in a direction traverse to the height direction of the device), and vice versa. The first range measured from the rotation axis R of the device 1 for picking up and depositing loads or objects is defined by moving the pickup body 7 from the first position into the second position.

The pickup body is a rigid chain actuator 7, wherein a chain end of the rigid chain actuator 7 is provided with pick-up units 15 for picking up loads such as boxes and the like. The pick-up units 15 shown in the drawings are suction cups. A load is detachable attachable by means of these suction cups to the pickup body in a hanging manner. As can be seen in FIG. 2c for example, the chain end of the rigid chain actuator 7 provided with pick-up units 15 extends radially outward in the first retracted position with respect to the rotation axis R. The main portion of the chain of the rigid chain actuator 7 is located inside the carrying body 5 in the first position. Hence, the first position of the pickup body can be used to hold and/or deposit loads 10, see FIG. 3b, in particular elongate loads 10. Instead of suction cups, the pick-up units may also be provided by clamping arms, magnetic pick-up device(s) or other pick-up device(s).

The device 1 further comprises a guiding body 17 for moving the carrying body 5 and the pickup body 7 in a direction traverse to the rotation axis R of the rotator 9. An example of a direction traverse to the rotation axis R of the rotator 9 is indicated in FIG. 1b by arrow P2. The rotation axis R substantially extends in a vertical direction, such that a direction traverse to the rotation axis of the rotator substantially extends in a horizontal direction under normal operating conditions of the device. The guiding body 17 is an elongate guiding body 17, such that the largest dimension of the guiding body 17, i.e. the longitudinal direction, extends substantially traverse to the rotation axis R of the rotator 9. The largest dimension of the elongate carrying body 5, i.e. the longitudinal direction, extends in the same direction as the rotation axis R of the rotator. The guiding body 17 is provided between the carrying body 5 and the rotator 9. The rotator 9 is directly connected to the supporting body 3 in the device 1 shown in FIGS. 1a-3b. The first pickup range is further extended into a second pickup range measured from the rotation axis R by means of the guiding body 17 which moves the carrying body 5 and the pickup body 7 in a direction traverse to the rotation axis R of the rotator 9. The distance d (FIG. 1a) between the rotation axis R and the end 7a of the pickup body 7 corresponds to the radius of the second pickup range measured from the rotation axis R. The at least one supporting body 3 shown in the figures is an elongate supporting body 3 with a longitudinal axis extending in a direction traverse to the direction of the longitudinal axis of the elongate carrying body 5.

It is also possible to provide the rotator 9 between the guiding body 17 and the carrying body 5, this configuration of the device is not shown in the drawings.

The guiding body 17, the carrying body 5 and the pickup body can by rotated by means of the rotator 9 around the rotation axis R through a rotation angle between 0-360 degrees. It is also possible that the rotation angle is limited to 180 degrees or 90 degrees.

The guiding body 17 is configured to be moved with respect to the rotator 9 (or the supporting body 3) in a first direction traverse to the rotation axis R of the rotator and the guiding body 17 is configured to move the carrying body 5 and the pick up body 7 with respect to the guiding body 17 in a separate movement traverse to the rotation axis R of the rotator. The separate or double movement may be in the first direction or in another direction traverse to the rotation axis R of the rotator 9 after rotating the guiding body 17 by the rotator 9 over an rotation angle between 0-360 degrees. The sequence of the double movements traverse to the rotation axis R of the rotator 9 by means of the guiding body 17 may also be the other way around and may also be simultaneously. The guiding body 17 may be connected to by a rail-like construction to the rotator 9 and by a second rail-like construction with the carrying body 5 to provide a double-movement guiding body 17. Other constructions for the double-movement guiding body 17 are also possible. By the double-movement guiding body 17, elongate loads 10 can be rotated requiring minimal space around the lift truck 20 and the device 1 seen from above, in particular when the pickup body with the load is moved from the second position to the first position, such that the center of the elongate load 10 can be brought relatively close to, or even coincide with, the rotation axis R of the rotator 9. In other words, the device 1 is configured to position the end 7a adapted for pickup at a relatively large number of possible rotation positions in the second pickup range.

As shown in FIG. 3a,b, the device 1 can be used for picking up or laying down elongate loads 10 without moving the lift truck 20 in a driving direction indicated by arrow P3 and without requiring any steering during pick-up or put down of a load. In this manner, the lift truck 20 and the device 1 can be used in warehouses with aisles between the shelves with the loads 10, 10′, wherein by means of the device as disclosed loads can be picked up or deposited in the shelves divided by the aisle, i.e. shelves located on opposite sides of the lift truck 20. The width of the aisle may be relatively small, for example the aisle width may be such that turning of the lift truck 20 is not possible in the aisle, whereas loads can be picked up or deposited in the shelves by means of the device 1. The device 1 is able to move a load 10 independent from the lift truck 20.

The maximum width of the lift truck 20 for driving the lift truck in a direction indicated by arrow P3 in the aisle is indicated by arrow W1 in FIG. 3a. Hence, width W1 of the lift truck 20 is the minimal width of the lift truck 20. The width of the aisle may be any width larger than width W1 of the lift truck 20. As shown in FIG. 3a, the additional width W2 to be obtained with the device 1 is shown in FIG. 3a. Hence, the second pickup range of the device 1 for picking up and rotating loads 10, 10′ is relatively large, whereas its width W1 for driving the lift truck 20 though aisles is relatively small.

The operation of the device 1 is explained by means of FIGS. 2c and 3a, b. The device 1 may start its operation from the state shown in FIG. 2c, but other states/positions are possible. Normally, the pickup body 7 is in its first position and the elongate guiding body 17 is rotated by means of rotator 9 to a position (as shown in FIGS. 2c, 3b) such that the width of the device 1 does not exceed width W1, i.e. a width such that the lift truck 20 can be driven through an aisle in one of the two directions indicated by arrow P3 to a position in the aisle as shown in FIG. 3a to pick up the elongate load 10. As a result of the minimal width W1 of the lift truck, the width dimension of the aisles may also be minimal, such that the capacity of the warehouse can be maximized. It is possible to pick up elongate loads 10 by means of the additional width W2 provided by the device 1 at a relatively larger distance seen from the supporting body 3 or the rotation axis R, wherein the additional width W2 is at least width W1. More preferred, the width W2 is at least 1.5 times the width W1, even more preferred the width W2 is at least 2 times the width W1.

Starting from the state of the device shown in FIG. 2c, the following actions/steps may be performed and in random order to obtain the state of the device 1 as shown in FIG. 3a (sub steps are also possible such as for example to lower the device 1 as a first step and as a last step):
the rotator 9 will rotate the elongate guiding body 17, the carrying body 5 and the pickup body 7 about 90 degrees,
the carrying body 5 and the pickup body 7 will be moved with respect to the elongate guiding body 17 from the first end 17a of the elongate guiding body 17 to its second end 17b,
the pickup body 7 is moved from the first position in which the pickup body at least mainly vertically extends in or along the carrying body 5 to the second position in which the pickup body 7 at least mainly horizontally extends outside or away from the carrying body 5,
the vertical guide track 22 of the lift truck 20 will lower the device 1.

When using suction cups as the pick-up units 15, the last step will be to lower the device 1 by means of the lift truck 20 such that the suction caps can be connected to the elongate load (package or box) 10 for pick up.

After the elongate load 10 has been picked up by the device 1 (FIG. 3a) the following actions/steps may be performed:
the vertical guide track 22 of the lift truck 20 will lift the device 1 and the load 10 connected thereto.
the pickup body 7 is moved from the second position to the first position,
the double movement function of the guiding body 17 is carrier out, i.e. the guiding body 17 is moved with respect to the rotator 9 such that end 17a moves away from supporting body (compare FIGS. 3a and 3b) and carrying body 5 is moved from the second end 17b to the first end 17a, wherein the two movements of the guiding body 17 may be performed simultaneously and even simultaneously with the movement of the pickup body 7 between the second position to the first position to reduce handling time,
the rotator 9 will rotate the elongate guiding body 17, the carrying body 5 and the pickup body 7 about 90 degrees to align the elongate load 10 with the loads 10 in the stack,
the guiding body 19 may be used to align the ends of the load 10 with the ends of the loads 10 in the stack,
the vertical guide track 22 of the lift truck 20 will lower the device 1 and the load 10 connected thereto to deposit the load 10 on the stack of loads on the pallet 30 as shown in FIG. 3b.

The number and order of actions/steps may differ. The steps to be performed by the device 1 may also depend on the space required for turning the elongate load 10 by the rotator 9. For example, it is possible to perform sub steps, such as for example a sub step to rotate over 10 degrees by the rotator 9 and to move the pickup body 7 to a position between the second and first position and/or to use at least one of the movements of the double movement guiding body 17. Elongate loads 10 being relatively long with a relatively small width are normally relatively difficult to handle, in particular to rotate in a situation as shown in FIG. 3a with a relatively high stack of loads on pallet 30 and a relatively high stack of loads next to the load to be picked up (or to be deposited). By using the double-movement guiding body 17 and the movable pick-up body 7 the position of rotation of the elongate load 10 can be chosen, because the center of the elongate load 10 can be brought to the most optimal position for rotation of the long load 10, such as for example relatively close to the rotation axis R. Such an optimal position of the center of the load 10 may for example coincide with the center of the aisle between two opposite shelves. Further, it is also possible by using the above steps in an opposite way to pick up a load 10 from the pallet 30 and to deposit the load in the shelve.

By using the double-movement guiding body 17 and the movement of the pickup body 7 between the second position to the first position or vice versa, the device 1 is able to handle elongate loads by providing more flexibility for positioning the center of the load 10 with respect to the rotation axis R to an optimal position depending on the specific conditions.

The lift truck 20 is configured to move the device 1 with the elongate load in a vertical direction, wherein the device 1 is configured to rotate the elongate load around rotation axis R and to move the load in a horizontal direction, preferably by using a guiding body 17, the carrying body 5 and the pickup body 7 as disclosed herein.

The figures used in this disclosure are schematic figures to demonstrate the main principles of the device 1.

Further, it is also possible with the device 1 to pick up and deposit a load 10′ with different dimensions than elongate load 10.

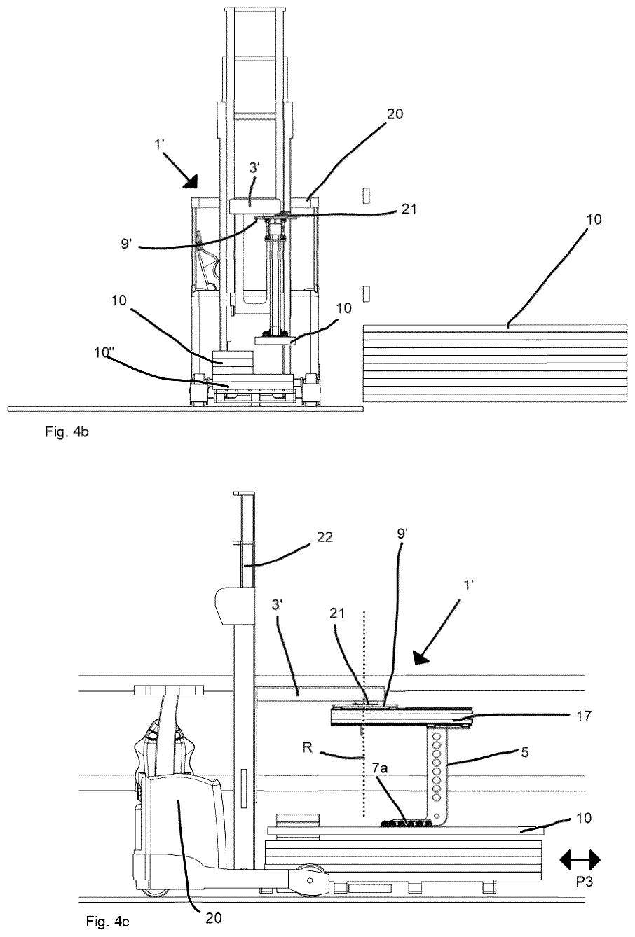

FIGS. 4a-c show perspective views of the lift truck 20 and a modified device 1′ for picking up and depositing loads 10, 10′, 10″ with respect to the device shown in the other figures. The modified device 1′ is almost identical to device 1 with the exception that the rotator 9′ is connected to the supporting body 3′ by means of a guiding unit 21. Hence, the above disclosure of the device 1 is also applicable to device 1′. For sake of brevity reference hereafter will be made for the components of device 1′ to the corresponding components of the device 1 described above, i.e. only the guiding unit 21 will be explained below.

The guiding unit 21 is provided between the rotator 9′ and the supporting body 3′. The guiding unit 21 may also be mentioned a side shift mechanism. By means of the guiding unit 21 the elongate guiding body 17, the carrying body 5 and the pickup body 7 can be moved in a direction traverse to the rotation axis of the rotator, in particular the guiding unit 21 is adapted for moving the carrying body 5 and the pickup body 7 in a direction transverse to the direction of displacement of the guiding body 17, i.e. crosswise. In this way, the guide unit 21 can advantageously assist in depositing elongate loads 10, 10″ in a predetermined orientation, for example in depositing elongate load 10 parallel to and next to another elongate load 10 on the pallet 30.

By means of the guiding unit 21 the range measured from the rotation axis R of the device 1′ for picking up and depositing loads or objects can be increased. In other words, the second pickup range is further extended into a third pickup range by means of the guiding unit 21 which moves the guiding body 17, the carrying body 5 and the pickup body 7 in a direction traverse to the rotation axis R of the rotator 9′. Further, it is possible to move the rotator 9′, guiding body 17, carrying body 5 and pickup body 7 from the center of width W1 to a more optimal position such as closer to the shelve as shown in FIG. 4a or a more optimal position with respect to weight distribution. In addition, the guide unit 21 can advantageously assist in depositing a load in a predetermined orientation, for example in depositing one elongate load parallel to and next to another elongate load 10. The latter is shown in FIGS. 4a-c. These FIGS. 4a-c demonstrate that if the elongate guide body 17 extends in the driving direction indicated by arrow P3, it is still possible to move the carrying body 5 and the pickup body 7 in a direction traverse to the driving direction indicated by arrow P3 by means of the guiding unit 21. In this manner it is possible to deposit elongate loads 10 in a parallel manner next to each other on a pallet 30 as shown in FIGS. 4a-c.

After collecting or depositing one or a number of loads 10, 10′ by means of the lift truck 20 and the device 1,1′, the lift truck 20 can be driven to a different position for collecting or depositing a load or loads 10, 10′, 10″ by means of the device 1, 1′ as disclosed in this document. As shown, the dimensions of the loads 10, 10′, 10″ may vary.

1.-15. (canceled)

16. A device for picking up and depositing loads comprising at least one supporting body, at least one carrying body and at least one pickup body configured for picking up and depositing at least one load, wherein the pickup body is movable between a first position in which the pickup body at least mainly extends in or along the carrying body and a second position in which the pickup body at least mainly extends outside or away from the carrying body, wherein the carrying body is connected to the supporting body by means of a rotator for rotating the carrying body and the pickup body around a rotation axis.

17. The device according to claim 16, wherein the device further comprises a guiding body for moving the carrying body and the pickup body in a direction traverse to the rotation axis of the rotator, preferably the guiding body is a double-movement guiding body.

18. The device according to claim 16, wherein the pickup body is a rigid chain actuator, wherein a chain end of the rigid chain actuator is provided with pick-up units for picking up loads such as boxes, preferably the pick-up units are suction cups.

19. The device according to claim 17, wherein the guiding body is provided between the carrying body and the rotator.

20. The device according to claim 16, wherein the device further comprises a guiding unit for moving the carrying body and the pickup body in a direction traverse to the rotation axis of the rotator.

21. The device according to claim 20, wherein the guiding unit is provided between the rotator and the supporting body.

22. The device according to claim 16, wherein the supporting body is mounted or adapted to be mounted on a lift truck.

23. The device according to claim 22, wherein by means of the lift truck the supporting body is moveable in the same direction as the rotation axis of the rotator.

24. The device according to claim 16, wherein the rotation axis substantially extends in a vertical direction, such that a direction traverse to the rotation axis of the rotator substantially extends in a horizontal direction.

25. The device according to claim 16, wherein the largest dimension of the supporting body extends substantially traverse to the rotation axis of the rotator and/or the largest dimension of the carrying body extends in the same direction as the rotation axis of the rotator.

26. The device according to claim 16, wherein in the first position the pickup body mainly extends in the same direction as the rotation axis of the rotator, wherein in the second position the pickup body mainly extends in a direction traverse to the rotation axis.

27. A lift truck comprising a device for picking up and depositing loads comprising at least one supporting body, at least one carrying body and at least one pickup body configured for picking up and depositing at least one load, wherein the pickup body is movable between a first position in which the pickup body at least mainly extends in or along the carrying body and a second position in which the pickup body at least mainly extends outside or away from the carrying body, wherein the carrying body is connected to the supporting body by means of a rotator for rotating the carrying body and the pickup body around a rotation axis.

28. The lift truck according to claim 27, wherein the device is provided on a vertical guide track at the front side of the lift truck.

29. The lift truck according to claim 27, wherein at the front side, the lift truck further comprises a carrier for loads or a carrier for a pallet or the like.

30. A method for picking up and depositing loads comprising at least one supporting body, at least one carrying body and at least one pickup body configured for picking up and depositing at least one load, comprising the steps of:
enabling the pickup body to be movable between a first position in which the pickup body at least mainly extends in or along the carrying body and a second position in which the pickup body at least mainly extends outside or away from the carrying body,
connecting the carrying body to the supporting body by a rotator for rotating the carrying body and the pickup body around a rotation axis.
